(19) United States
(12) Patent Application Publication
(10) Pub. No.: US 2015/0274419 A1
(43) Pub. Date: Oct. 1, 2015

(54) METHOD FOR HANDLING MATERIAL IN A MATERIAL CONVEYING SYSTEM, INPUT POINT OF A MATERIAL CONVEYING SYSTEM, AND A MATERIAL CONVEYING SYSTEM

(71) Applicant: MARICAP OY, Vantaa (FI)

(72) Inventor: Göran Sundholm, Tuusula (FI)

(73) Assignee: MARICAP OY, Vantaa (FI)

(21) Appl. No.: 14/437,379

(22) PCT Filed: Oct. 21, 2013
(86) PCT No.: PCT/FI2013/050993

§ 371 Date: Apr. 21, 2015

(30) Foreign Application Priority Data
Oct. 22, 2012 (FI) 20126093

(51) Int. Cl. B65F 5/00; B65F 1/12; B65G 53/40; B65G 53/26; B65F 1/10

(52) U.S. Cl. CPC B65F 5/005; B65G 53/26; B65F 1/105; B65G 53/40; B65F 1/125

(57) ABSTRACT

Method for feeding and transporting material in a pneumatic material conveying system includes an input point connected to a material conveying pipe and a material container, wherein the material to be transported is separated from the transporting air. A partial vacuum/pressure difference and/or a transporting air flow is achieved in the conveying pipe at least during the transporting of material. The suction side of the partial-vacuum source is connected to the conveying pipe and onwards to an input point arranged in the conveying pipe or at least to the feed-in channel that is between the conveying pipe and an input point, wherein the input point, or at least the feed-in channel, that is closest to the material container in the conveying direction of the material empties and the material displaces into the conveying pipe. A wall for closing the pathway between an input aperture and the conveying pipe is provided.

### BACKGROUND OF THE INVENTION

The object of the invention is a method as defined in the preamble of claim 1.

The object of the invention is also an input point, according to claim 8, of a material conveying system.

The object of the invention is also a material conveying system according to claim 19.

The invention relates generally to pneumatic material conveying systems, such as to partial-vacuum transporting systems, more particularly to the collection and conveying of wastes, such as to the conveying of household wastes and litter.

Systems wherein wastes are conveyed in piping by means of suction and/or transporting air are known in the art. In these, wastes are moved long distances in the piping pneumatically, by means of suction and/or a pressure difference, together with the transporting air. The apparatuses are used for, among other things, the conveying of wastes in different institutions, for the conveying of household waste or for the conveying of other waste. It is typical to these systems that a partial-vacuum apparatus is used to achieve a pressure difference, in which apparatus negative pressure is achieved in the conveying pipe with partial-vacuum generators, such as with vacuum pumps or with an ejector apparatus. A conveying pipe typically comprises at least one valve means, by opening and closing which the replacement air coming into the conveying pipe is regulated. One of the convenient solutions of new regional building projects is waste management that will operate with a pipe transport system. This means that sorted wastes are sucked along underground pipes to a waste station that is common to the whole region. The system is clean, odorless and noise-free, and is also a more environmentally friendly solution than conventional waste management and a safer solution from the viewpoint of the nearby environment. On the other hand, there are a lot of quite small sites, such as office properties, commercial properties, industrial properties and especially residential properties or other sites, in which it is desired to achieve a pneumatic pipe transport solution for wastes, but which are not economically viable to equip with their own partial-vacuum generating apparatus or with a separating device and a separate container. Additionally, one problem is that the litter bins in parks and public spaces are emptied too seldom. Another problem is also that objects are put into them, which can be problematic for the personnel manually emptying them, such as sharp objects, e.g. syringes used for drugs or corresponding.

In prior-art solutions the input points for material often have complex valve arrangements with which the connection of an input point to the conveying piping and/or the access of replacement air from an input point into the conveying piping is controlled. In many cases complex input point arrangements are undesirable. Indeed, needs have arisen wherein the aim is a simpler input point than earlier, having investment costs and operating costs that are advantageous with respect to known solutions and the maintenance of which is easy.

The aim of the present invention is to achieve a novel solution in connection with material conveying systems, by means of which solution the drawbacks of prior art solutions are avoided. Another aim of the invention is to achieve a solution more particularly for rather small systems, in which it is not desired to use complex input points. Yet another aim is to achieve a wastes conveying system, which is suited for use in the collection of the litter of public spaces, such as parks.

### BRIEF DESCRIPTION OF THE INVENTION

The invention is based on a concept wherein a channel with a wall changing its shape is arranged between an input aperture of an input point and a conveying pipe, owing to the flexing movement of the wall of the channel, which wall changes its shape, the pathway of the channel is arranged to close or the flow cross-sectional area of the pathway of it essentially decreases, when pressure, more particularly negative pressure, lower than the pressure of the environment is acting in the channel.

The method according to the invention is characterized by what is stated in the characterization part of claim 1.

The method according to the invention is also characterized by what is stated in claims 2-7.

The input point, according to the invention, of a material conveying system is characterized by what is stated in claim 8.

The separating device, according to the invention, for a material conveying system is also characterized by what is stated in claims 9-18.

The material conveying system according to the invention is characterized by what is stated in the characterization part of claim 19.

The material conveying system according to the invention is also characterized by what is stated in claims 19-23.

The solution according to the invention has a number of important advantages. By means of the solutions of the invention the drawbacks of prior art are avoided. In the solution according to the invention an input point that is surprisingly simple in terms of its means can be applied, the connection of the input aperture of which input point to the conveying pipe opens and closes automatically as a result of the suction produced by a partial-vacuum source and of the wall that changes its shape. In this case also the access of replacement air via the input aperture is limited automatically. The method, input point and system according to the invention do not require complex valve arrangements in connection with the input points. With the solution according to the invention the waste management of public spaces, e.g. parks, can be efficiently managed, in which case when replacing conventional litter bins with input points according to the invention the manual emptying of litter bins is avoided and at the same time the manual handling of possible dangerous objects in connection with emptying is avoided. The wall changing its shape of the solution according to the invention is preferably tubular, through which the channel between an input aperture and the conveying pipe runs. An aperture or apertures are formed in the envelope functioning as the frame of an input point, the air pressure surrounding which aperture or apertures is able to act on the wall that changes its shape from the outside of it. With the solution according to the invention an effective and structurally simple solution for constricting and closing the channel between an input point and a conveying pipe is achieved. The solution according to the invention is well suited for use in connection with different types of pneumatic material conveying systems. The material collection container of the system can be fixed or it can be a transportation container or a so-called deep collection container-separating device. By using a deep collection container as a separating device, the material conveyed into the collection container can be efficiently stored, and emptying of the container can be performed less frequently. Emptying of the collection container can be performed by lifting the collection container and by transferring the material that has collected in the container from an openable and closable aperture arranged in the bottom part of the container into the container of a transportation means, such as of a garbage truck. The transportation means can comprise a press for compressing the material so it becomes denser and a hoist for lifting the collection container. With the solution according to the invention, the separating device of a pneumatic pipe transport system for material and the collection container intended for temporary storage of the transported material can be efficiently combined. When the collection container is a so-called deep collection container, which is at least partly embedded below the surface level of the ground, or corresponding surface level, the space requirement can be efficiently reduced. According to one preferred embodiment the deep collection container-separating device comprises a collection container and an external container, into which the collection container is arranged and from which the collection container is lifted for emptying. A mobile partial-vacuum generating apparatus can be used effectively in connection with the material conveying system of the invention to achieve the partial vacuum needed in the pneumatic transportation of material. In this case a dedicated fixed partial-vacuum generating apparatus is not needed in individual material conveying systems. The system thus enables the division of effective operating time of the partial-vacuum source between many material conveying systems. The system also enables the offering of the partial-vacuum source of a material conveying system as a service to properties. In addition, the invention enables an effective way to ensure material conveying by using many mobile partial-vacuum sources, in which case e.g. in a malfunction situation a primary partial-vacuum source can easily be replaced with a second mobile backup apparatus. The mobile partial-vacuum source according to the invention fits to function in more cramped locations also because it can be arranged in a vehicle, in which space for wastes is not needed at the same time. The solution according to the invention effectively enables a different frequency for the operation of the partial-vacuum source and for the emptying of a container.

### BRIEF DESCRIPTION OF THE FIGURES

In the following, the invention will be described in more detail by the aid of an embodiment with reference to the attached drawings, wherein

FIG. 1 presents, as a simplified cross-section along the line I-I of FIG. 1a, an input point according to an embodiment of the invention when connected to a conveying pipe,

FIG. 1a presents a cross-section along the line Ia-Ia of FIG. 1,

FIG. 2 presents as a cross-section an input point of an embodiment of the invention, in a second operating state,

FIG. 2b presents an input point of the embodiment from the direction of the arrow b of FIG. 2,

FIG. 3 presents an input point according to an embodiment of the invention,

FIG. 4 presents an input point according to an embodiment of the invention, partially sectioned along the line IV-IV of FIG. 4a,

FIG. 4a presents a cross-section along the line IVa-IVa of FIG. 4,

FIG. 5 presents in the manner of a series of drawings a partially-sectioned side view of the operation of a system according to an embodiment of the invention,

FIG. 6 presents a system according to an embodiment of the invention,

FIG. 7 presents a system according to an embodiment of the invention,

FIG. 8 presents a second system according to the invention, and

FIG. 8a presents the emptying phase of the collection tank of the system of FIG. 8.

### DETAILED DESCRIPTION OF THE INVENTION

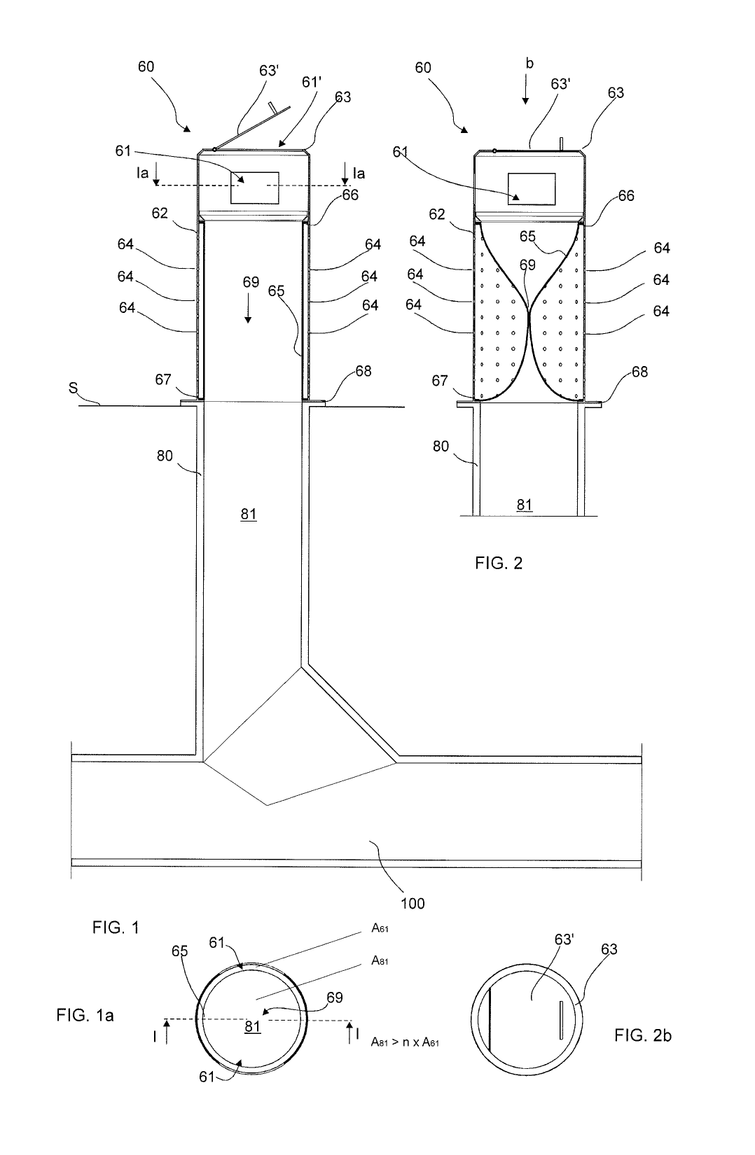

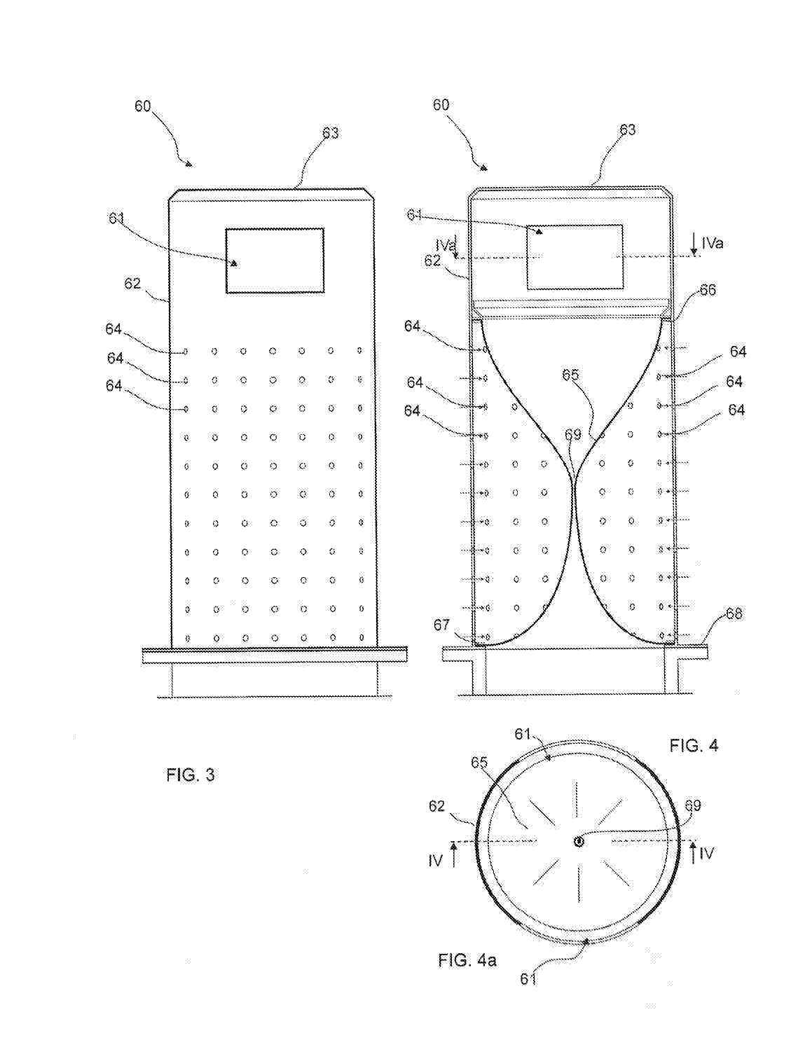

FIGS. 1-4 present a part of a pneumatic material conveying system, which part comprises a material conveying pipe 100, along the side of which at least one, typically many, input points 60 are arranged. An input point 60 is a feed-in station for material, more particularly of waste material, intended to be transported, from which station the material, more particularly waste material, such as litter, household waste, or recyclable material intended to be transported, is fed into the conveying system. An input point 60 can also be a refuse chute, into which material is fed from input apertures on different floors of a building. The system can comprise a number of input points 60, from which the material intended to be transported is fed into conveying piping 100, 100A, 100B, 100C. An input point 60 is connected to the conveying pipe 100 or to an input pipe 80 in connection with it. Inside the input pipe is a feed-in channel 81, which extends to the conveying pipe 100. In the figure the input point 60 is arranged above a mounting surface s, such as above the level of the surface of the ground. The feed-in channel 81 extends to a conveying pipe 100 running below the surface of the ground, in which case there is a pathway from the input aperture 61 of the input point via the feed-in channel 81 into the conveying pipe 100. A channel part having a wall 65 that changes its shape is arranged in connection with an input point 60 in the pathway between the input aperture 61 and the material conveying pipe 100. In the figure, the wall 65 changing its shape is a tubular part, which forms part of the pathway from the input aperture 65 into the conveying pipe 100. The wall 65 changing its shape is arranged in an input point between the input aperture and the feed-in channel 81. The top part 66 of the wall changing its shape is arranged in the input point below the input aperture of it. The bottom part 67 of the wall changing its shape is arranged in the bottom part 68 of the frame of the input point. An input point comprises a frame, comprising a side wall 62 and a top wall 63. There are one or more input apertures 61, in the embodiment of the figure two, which are arranged in the side wall 62, in the top part of it, to open to opposite sides of the input point. In the embodiment of the invention the side wall 62 is an envelope part, which surrounds the wall part 65 that changes its shape and that is arranged inside it. In the side wall is formed at least one aperture 64, in the figure number of apertures 64, through the envelope, in which case the wall changing its shape is in medium connection on its outside with the surrounding atmosphere. From the input aperture of an input point in the situation of FIG. 1 is a pathway 69 through the channel forming a wall that changes its shape and through the feed-in channel 81 into the conveying pipe.

FIGS. 2, 4 and 4a present a situation in which a suction effect brought about by the partial-vacuum generator of a pneumatic material conveying system acts in the pathway, in the feed-in channel 81. The flow cross-sectional area A₈₁ of the feed-in channel 81 is greater than the flow cross-sectional area A₆₁ of the open input aperture 61 of the input point 60 or the sum ΣA₆₁ of the flow cross-sectional areas of a number of input apertures of an input point, in which case the pressure of the environment acting via the apertures 64 of the wall 62 acts from the outside on the wall changing its shape and owing to the pressure difference the wall 65 changing its shape flexes and/or bends inwards in the channel constricting the pathway 69, closing the pathway or at least essentially reducing the flow cross-sectional area of the pathway. In this case the access of replacement air coming via the input apertures 61 of the input point 60 of the figure into the conveying pipe 100 decreases and possibly ceases.

FIGS. 1, 1a, 2, 2b present an embodiment wherein an input aperture 61′ is arranged in the top wall 63 of the input point, which input aperture is provided with an openable and closable hatch 63′. In this case material that is such that it is not suited, in terms of its size or other properties, for feeding in via an input aperture 61 on the side, can be fed into the input point via the input aperture 61′ provided with a hatch 63′. The hatch 63′ is arranged in the closed position, when the suction of the partial-vacuum source 30 is connected to act in the input point 60. In this case the flow cross-sectional area of the input apertures is configured to be smaller than the flow cross-sectional area of the pathway.

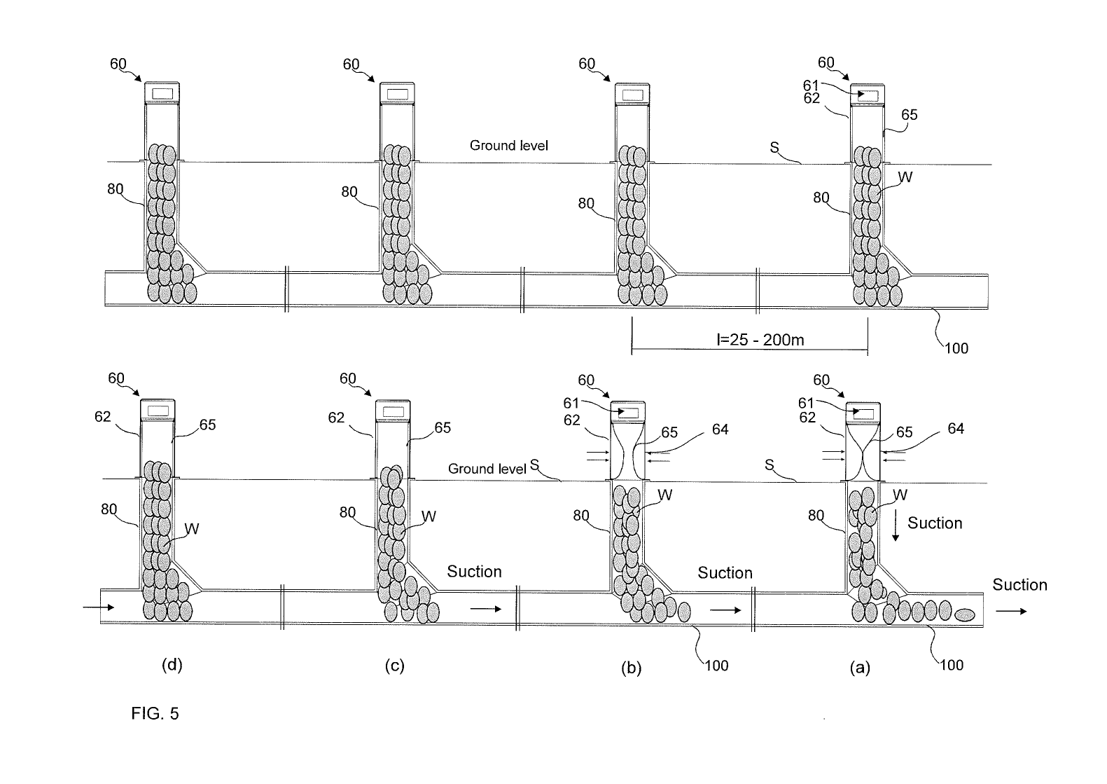

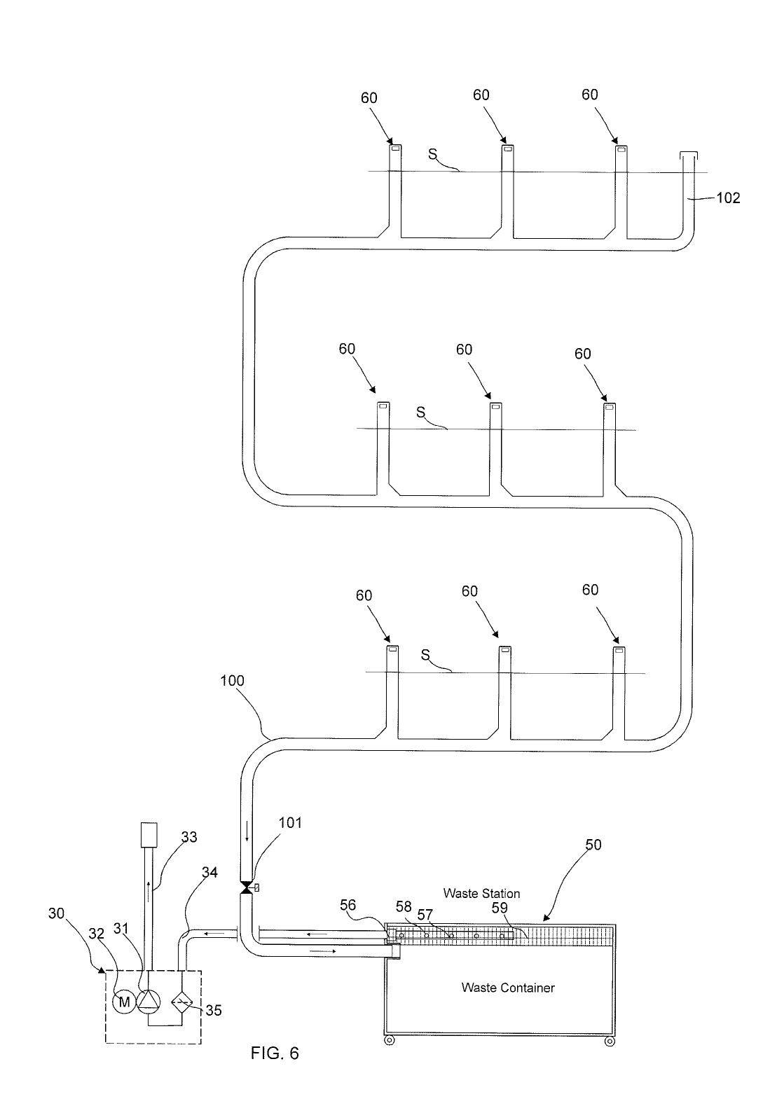

FIG. 5 presents in a simplified manner of a series of drawings the operation of an embodiment of the invention. The top row of the figure presents a number of input points, which are arranged in the feed-in channel section 80 of the conveying pipe 100. Material W, e.g. waste material, litter, et cetera, has been fed into them via an input aperture 61 of the input points. By the aid of gravity the material has displaced from the input aperture 61 of an input point in the channel 81 that is inside the feed-in channel part 80 to as far as into the conveying pipe 100, which in the figure is a horizontal pipe, while the feed-in channel part 80 is a vertical pipe section. The distance between input points can vary. According to one embodiment the intermediate distance I can be e.g. 25-200 m. The bottom row of FIG. 5 presents a situation when the suction side of the partial-vacuum generator of the pneumatic material conveying system is connected to act in the conveying pipe. In the figure, the suction is acting from the right-hand side, in which direction the material tries to move. At point (a) of the bottom row the suction has acted in such a way that the material starts moving along with the transporting air in the conveying pipe while replacement air comes both in the conveying pipe and via an input aperture of an input point in the direction in which the suction acts at first from the input point closest in the material conveying direction.

In practice the input point that is nearest the material container of the material conveying system empties first. When the negative pressure is able to act on the wall of an input point, said wall being one that changes its shape, as a consequence of the pressure difference the wall flexes and/or bends, constricting the pathway essentially or closing the pathway between the input aperture of the first input point and the conveying pipe. In FIG. 5 the pathway between the input aperture of an input point and the feed-in channel part 80 closes. At the same time the suction already acts in the second input point in FIG. 5 (b), the material of which displaces in the conveying pipe towards the delivery end of material, i.e. the material container, and at the same time downwards in the feed-in channel into the conveying pipe. When the strength of the suction acts on the wall of the second input point, said wall being one that changes its shape, it also starts to flex and/or bend constricting the pathway essentially or closing the pathway between the input aperture of the second input point and the conveying pipe. In a corresponding manner the suction effect progresses in the conveying piping and empties the input points. When all the input points have been emptied and each of their feed-in channels have, as a consequence of the flexing or bending of the wall that changes its shape, constricted the pathway essentially or closed the pathway between the input aperture of each input point and the conveying pipe, the suction of the partial-vacuum generator can be switched off. The containers can again be filled via the input apertures until they are emptied the next time

FIGS. 6, 7 and 8 present various material conveying systems according to an embodiment of the invention. In the embodiment according to FIG. 6 input points 60 are arranged along the conveying pipe 100. At the end of the conveying pipe is a replacement air duct 102. The conveying pipe is connected to a collection container 50 for material at its other end. A valve is arranged in the conveying pipe, with which valve the connection from the material conveying pipe into the material collection container is opened and closed. A suction pipe 57 having apertures 58 that open into the container space of the material collection container is arranged in the material collection container. A wall 59 allowing air to pass through, such as a net, that prevents waste material getting into the suction apertures of the suction pipe is arranged in the container. The suction pipe is connected with a connection 56 to the suction side channel 34 of the fan 31 of the partial-vacuum generator 30. The partial-vacuum generator is driven with a drive means 32. The blowing side of the partial-vacuum generator is connected to the exhaust pipe 33. In the embodiment of the figure a filtering means 35 is arranged in the duct of the suction side of the partial-vacuum generator.

The conveying piping 100 can be arranged to travel under the surface S of the ground or in cellars. In the embodiment of the figure the conveying piping comprises replacement air ducts 102. In the conveying situation, the valve means 101 between the conveying piping and the material collection container 50 is open and the partial-vacuum generator is connected to function, in which case the suction side of it is connected via the material collection container 50 to the conveying pipe 100. The input points 60 empty starting from the input point that is closest to the material collection container and the material displaces along with the transporting air into the material collection container 50, in which the material separates from the transporting air and remains in the container. The transporting air, for its part, is conducted from the container into the suction pipe 57 and via the suction channel 34 into the exhaust pipe 33. When the input points 60 have been emptied, the valve 101 can be closed and the partial-vacuum generator 30 can be stopped. The container in the embodiment of the figures is a transportation container, which is configured to be detachable from the conveying pipe and from the suction duct. The container can be transported for emptying elsewhere. It can be replaced with an empty container.

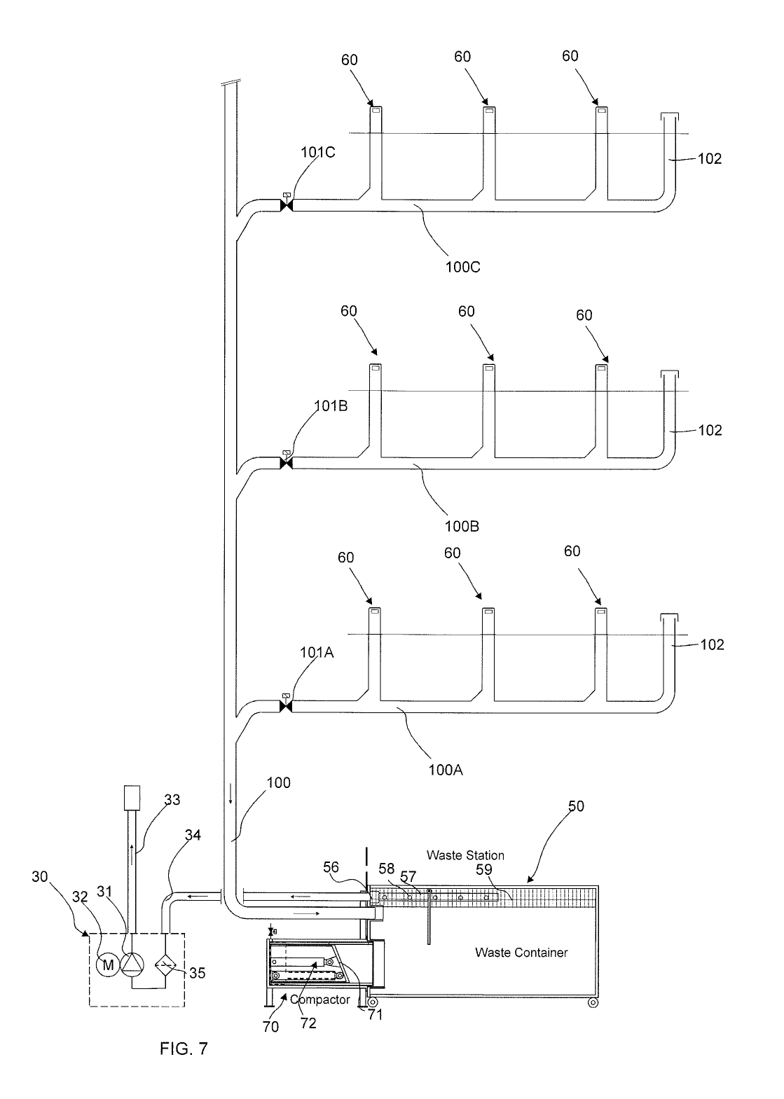

FIG. 7 presents second embodiment of a system according to the invention. In it a number of branch conveying pipes 100A, 100B, 1000 are arranged in the main conveying pipe 100, from which branch conveying pipes there is a connection, which is openable and closable with valve means 101A, 101B, 101C, into the main conveying pipe 100. Input points 60 are arranged at a distance from each other in the branch conveying pipes. In addition, there is a replacement air duct 102 in each branch conveying pipe. The main conveying pipe 100 is connected to the material collection container 50, in connection with which is arranged a press device/compactor device 70, with the compression means 71 of which the material in the material container 50 can be compressed/compacted, said compression means being driven with a drive device 72. The partial-vacuum generator in FIG. 7 corresponds with what is described in connection with FIG. 6. In the embodiment of FIG. 7 the input points 60 are emptied consecutively one branch conveying pipe at a time. In this case the connection from the main conveying pipe 100 into the branch conveying pipe in question is opened with the valve means 101A, 101B, 101C of the branch conveying pipe 100A or 100B or 100C in question that is intended for emptying, in which case the suction effect of the partial-vacuum generator 30 is able to act in the branch conveying pipe. The input points connected to the branch conveying pipe empty, beginning from the input point that is closest to the main conveying pipe and progressing in an emptying sequence that is in the opposite direction with respect to the material conveying direction.

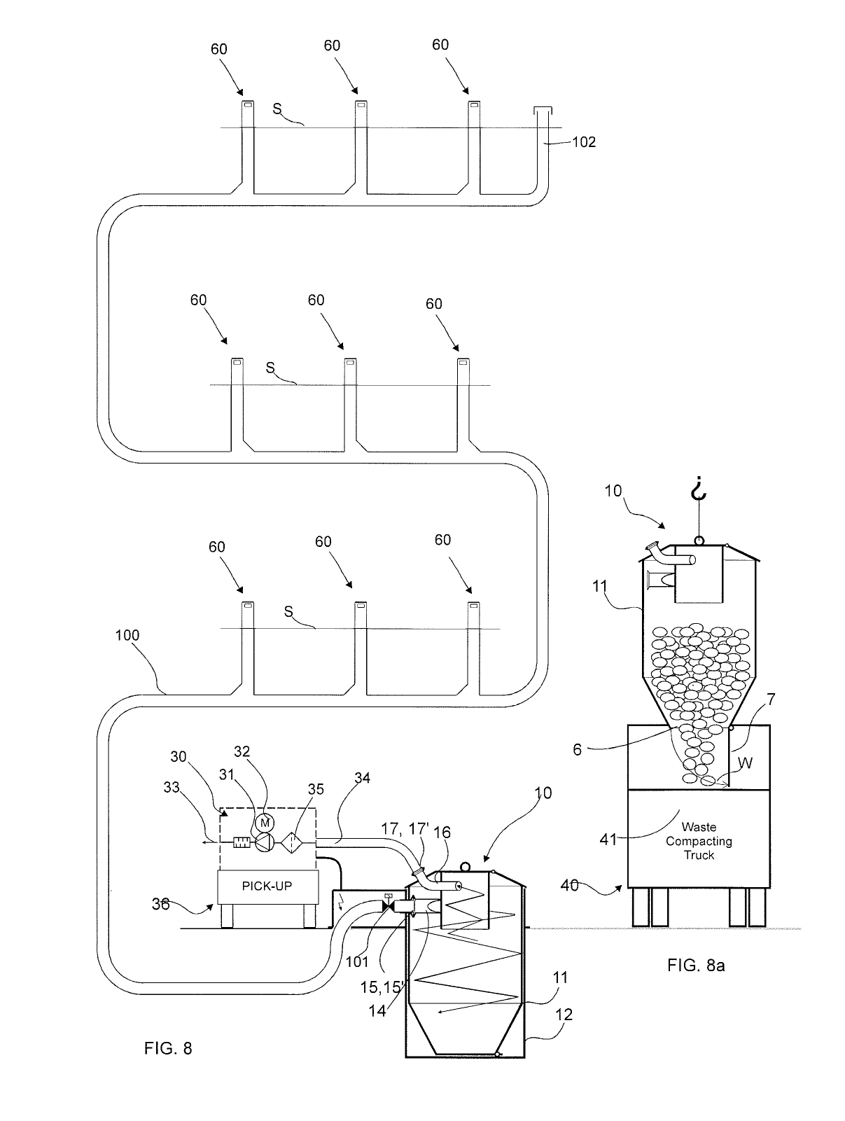

FIG. 8 presents yet another embodiment of the material conveying system according to the invention. In it as a material container is a separating device 10, which is a combination of a deep collection container for material, which is formed from an external container 12 and a collection container 11, and of means arranged in it separating the transporting air and the material being conveyed from each other. According to one embodiment the separating device is a so-called cyclone separator. The conveying pipe 100 can be connected to the collection container 11 of the separating device 10, in which collection container the material W being transported is separated from the transporting air. A connecting means 15′ is formed in the conveying pipe 100 and a counterpart 15 in the branch coupling 14 formed in the top part of the collection container 11. The connecting means 15′ and the counterpart 15 together form e.g. a snap-on coupling. A second connection 17 is formed in the collection container 11, into which connection a pipe or hose 34 coming from the partial vacuum source 30 can be connected with a counterpart 17′. The external container 12 of the deep collection container is embedded below the surface S of the ground or corresponding.

In the embodiment of the figure the partial-vacuum generator is arranged to be movable. According to the embodiment, the partial-vacuum source 30 is a movable apparatus arranged in a mobile means 36, e.g. in a vehicle. The mobile means 36 can be e.g. a small lorry or a van or the partial-vacuum source 30 can be arranged in a trailer, which can be towed by a vehicle.

In the embodiment of the figure, the material w, such as waste material, separated from the transporting air drifts to the bottom part of the collection container 11. In the figure the drifting of the separated material to the bottom part of the collection container 11 of the separating device 10 is described with an arrow. The material w is presented in the figure as grey. The separated material is removed, e.g. according to need, from the collection container. This material removal phase is presented e.g. in FIG. 8a, in which the collection container is lifted from the external container 12 with lifting means (the lifting device itself is not presented), into the container 41 of a transportation means, such as of a garbage truck 40, e.g. via an output aperture 6 for material arranged in the bottom part of the collection container 11, e.g. by opening the hatch 7 closing the output aperture 6.

The invention thus relates to a method for feeding in and, for transporting material in a pneumatic material conveying system, which conveying system comprises at least one input point 60 for waste material, a material conveying pipe 100, which can be connected to an input point 60, and a material container 10, 50, in which the material to be transported is separated from the transporting air, and also means for achieving a partial vacuum/pressure difference and/or a transporting air flow in the conveying pipe 100 at least during the transporting of material, which means comprise at least one partial-vacuum source 30. In the method the suction side of the partial-vacuum source 30 is connected to act in the conveying pipe 100 and onwards to act in an input point 60 arranged in the conveying pipe or at least to act in the feed-in channel 81 that is between the conveying pipe and an input point, in which case the input point 60 or at least the feed-in channel 81 that is closest to the material container in the conveying direction of the material empties and the material displaces into the conveying pipe 100, that the channel arranged between an input aperture 61 of an input point and the conveying pipe 100 comprises an elastic wall 65, with which elastic wall 65 the pathway between an input aperture 61 of an input point 60 and the conveying pipe 100 is closed or at least the flow cross-sectional area of the pathway is essentially reduced, when the pressure in the pathway is essentially smaller than outside the wall part 65 that changes its shape.

According to one embodiment the second, with respect to the input point first emptied, farther input point 60 from the material container 10, 50 in the conveying direction of material, or at least the material w that is in the feed-in channel 81 of it, is next emptied into the conveying pipe, in which case the channel arranged between the input aperture 61 of the second input point 60 and the conveying pipe 100 comprises a wall 65 that changes its shape, with which wall 65 changing its shape the pathway between the input aperture 61 of the input point and the conveying pipe 100 is closed or at least the flow cross-sectional area of the pathway is essentially reduced, when the pressure in the pathway is essentially smaller than outside the wall part 65 that changes its shape.

According to one embodiment the wall 65 changing its shape closes the pathway or constricts the flow cross-sectional area of the pathway making it smaller, when the pressure outside the wall 65 changing its shape presses the wall radially in the pathway towards the wall section on the opposite side.

According to one embodiment in the method the pathway of replacement air is closed or the pathway of replacement air from the input aperture of an input point 61 to the conveying piping 100 is essentially reduced by closing or reducing the flow cross-sectional area of the channel with the wall 65 that changes its shape, which bends and/or flexes as a result of the pressure difference of the pressures acting on a different side of the wall.

According to one embodiment the wall part that changes its shape returns and opens or essentially enlarges the flow cross-sectional area of the pathway between the input aperture 61 and the conveying pipe 100, when the suction effect brought about in the pathway by the partial-vacuum generator decreases or ends.

According to one embodiment material is fed in before the emptying of an input point 60 from the input aperture 61 of the input point along the feed-in channel 81 to as far as into the conveying pipe 100.

According to one embodiment the flow cross-sectional area A₆₁ of an open input aperture 61 of each input point 60 or the sum Σ A₆₁ of the flow cross-sectional areas of a number of open input apertures is kept smaller than the flow cross-sectional area A₈₁ of the channel 81 between the channel part comprising the wall 65 that changes its shape and the conveying pipe 100.

The object of the invention is also an input point of a pneumatic material conveying system, which input point comprises one or more input apertures for feeding in material into a feed-in channel, which is connected to a conveying pipe. A channel part is arranged between the input aperture 61 of an input point 60 and the conveying pipe 100, which channel part comprises a wall 65 that changes its shape, which wall 65 that changes its shape is configured to close the pathway 69 between the input aperture 61 and the conveying pipe 100 or to essentially reduce the flow cross-sectional area of the pathway of the channel, when the pressure in the channel is essentially smaller than outside the wall part 65 that changes its shape.

According to one embodiment the wall part changing its shape of the channel part comprising a wall part 65 that changes its shape is a tubular part.

According to one embodiment the flow cross-sectional area A₆₁ of the input aperture 61 of the input point is smaller than the flow cross-sectional area A₈₁ of the channel 81 between the channel part comprising the wall 65 changing its shape and the conveying pipe 100.

According to one embodiment the wall 65 changing its shape is a flexible wall. According to one embodiment the wall 65 changing its shape is arranged in such a way that in the first position, i.e. in the non-constricting position, there is surplus wall material, and the material of the wall in the second position, i.e. in the constricting position, tautens to essentially reduce or close the pathway between the input aperture 61 and the conveying pipe 100.

According to one embodiment an input point 60 comprises a number of input apertures 61, in which case the combined flow cross-sectional area ΣA₆₁ of the input apertures 61 that are open is smaller than the flow cross-sectional area A₈₁ of the channel between the channel part comprising an elastic wall and the conveying pipe 100.

According to one embodiment an input point 60 comprises an envelope part 62 outside in the radial direction the wall 65 that changes its shape, in which envelope part is formed an aperture 62 or a number of apertures 62, the pressure surrounding which is able to act on the wall 65 that changes its shape.

According to one embodiment the wall part 65 that changes its shape is configured to close the connection between the input aperture 61 and the conveying pipe 100 or to essentially reduce the flow cross-sectional area of the pathway of the channel as a consequence of the pressure difference between the suction effect brought about in the channel by the partial-vacuum generator of the pneumatic material conveying system and the pressure prevailing outside the wall part 65 that changes its shape.

According to one embodiment an input point 60 for material is an input point for waste material or recyclable material.

According to one embodiment an input point 60 for material is configured to function as a rubbish collection point, such as a litter bin.

According to one embodiment the wall 65 changing its shape is a collapsible or contractible part, such as a sock or hose, owing to the negative pressure acting inside the space bounded by it.

According to one embodiment the wall 65 changing its shape comprises a flexible sealing material, e.g. rubber or plastic.

According to one embodiment the wall 65 changing its shape comprises wear-resistant reinforcing fabric, such as steel fabric, on which is arranged a sealing material, such as rubber or plastic, on the side of the outer wall.

The object of the invention is also a pneumatic material conveying system, which comprises at least one input point 60 for material, which is connected to conveying piping 100 for material, means for achieving a partial vacuum/pressure difference/transporting air flow in the conveying piping, and also a material container 10, 50, into which the material to be transported together with the transporting air is conducted and in which the transporting air and the material to be transported are separated from each other. A channel part is arranged between the material input aperture 61 of an input point 60 and the conveying pipe 100, which channel part comprises a wall 65 that changes its shape, which wall that changes its shape is configured to close the pathway between the input aperture 61 and the conveying pipe 100 or to essentially reduce the flow cross-sectional area of the pathway of the channel, when the pressure in the channel is essentially smaller than outside the wall part that changes its shape.

According to one embodiment the system comprises a number of input points 60 arranged along the conveying piping 100, for emptying which input points the suction side of a partial-vacuum generator is connected to the material container and from where there is a flow connection onwards into the conveying pipe.

According to one embodiment the system comprises a material container 50, which is a transportation container.

According to one embodiment the system further comprises a material container, which is a deep collection container-separating device 10, into which material is conveyed from input points 60 via a conveying pipe 100, by means of suction/a pressure difference produced by a partial-vacuum source 21, and that in the emptying phase the collection container 11 is lifted with lifting means and the material w that has collected in the collection container 11 is emptied via an openable and closable aperture 6 arranged in the bottom part of the collection container 11.

According to one embodiment any of the aforementioned input points is configured for use in the system.

The mobile partial-vacuum source presented e.g. in publication WO2011151522, or an ordinary partial-vacuum source arranged in the proximity of the separating device, e.g. arranged in a container, can be used in the system and method according to the invention.

It is obvious to the person skilled in the art that the invention is not limited to the embodiments presented above, but that it can be varied within the scope of the claims presented below. The characteristic features possibly presented in the description in conjunction with other characteristic features can if necessary be used separately to each other.

1. Method for feeding in and for transporting material in a pneumatic material conveying system, which conveying system comprises at least one input point for material, a material conveying pipe, which can be connected to an input point, and a material container, in which the material to be transported is separated from the transporting air, and also means for achieving a partial vacuum/pressure difference and/or a transporting air flow in the conveying pipe at least during the transporting of material, which means comprise at least one partial-vacuum source, comprising the following steps:
connecting the suction side of the partial-vacuum source to act in the conveying pipe and onwards to act in an input point arranged in the conveying pipe or at least to act in the feed-in channel that is between the conveying pipe and an input point,
emptying the input point or at least the feed-in channel that is closest to the material container in the conveying direction of the material and the material displaces into the conveying pipe, and
arranging the channel between an input aperture of an input point and the conveying pipe to include a wall that changes its shape, with which wall changing its shape the pathway between an input aperture of an input point and the conveying pipe is closed or at least the flow cross-sectional area of the pathway is essentially reduced, when the pressure in the pathway is essentially smaller than outside the wall part that changes its shape.

2. Method according to claim 1, wherein the second, with respect to the input point first emptied, farther input point from the material container in the conveying direction of material, or at least the material that is in the feed-in channel of it, is next emptied into the conveying pipe, in which case the channel arranged between the input aperture of the second input point and the conveying pipe comprises a wall that changes its shape, with which wall changing its shape the pathway between the input aperture of the input point and the conveying pipe is closed or at least the flow cross-sectional area of the pathway is essentially reduced, when the pressure in the pathway is essentially smaller than outside the wall part that changes its shape.

3. Method according to claim 1, wherein the wall changing its shape closes the pathway or constricts the flow cross-sectional area of the pathway making it smaller, when the pressure outside the wall changing its shape presses the wall radially in the pathway towards the wall section on the opposite side.

4. Method according to claim 1, wherein in the method the pathway of replacement air is closed or the pathway of replacement air from the input aperture of an input point to the conveying piping is essentially reduced by closing or reducing the flow cross-sectional area of the channel with the wall that changes its shape, which bends and/or flexes as a result of the pressure difference of the pressures acting on a different side of the wall.

5. Method according to claim 1, wherein the wall part that changes its shape returns and opens or essentially enlarges the flow cross-sectional area of the pathway between the input aperture and the conveying pipe, when the suction effect brought about in the pathway by the partial-vacuum generator decreases or ends.

6. Method according to claim 1, wherein material is fed in before the emptying of an input point from the input aperture of the input point along the feed-in channel to as far as into the transfer pipe.

7. Method according to claim 1, wherein the flow cross-sectional area of an open input aperture of each input point or the sum of the flow cross-sectional areas of a number of open input apertures is kept smaller than the flow cross-sectional area of the channel between the channel part comprising the elastic wall and the conveying pipe.

8. Input point of a pneumatic material conveying system, which input point comprises one or more input apertures for feeding in material into a feed-in channel, which is connected to a conveying pipe, comprising:
a channel part is arranged between the input aperture of an input point and the conveying pipe, which channel part comprises a wall that changes its shape, which wall that changes its shape is configured to close the pathway between the input aperture and the conveying pipe or to essentially reduce the flow cross-sectional area of the pathway of the channel, when the pressure in the channel is essentially smaller than outside the wall part that changes its shape.

9. Input point according to claim 8, wherein the elastic wall part of the channel part comprising an elastic wall part is a tubular part.

10. Input point according to claim 8, wherein the flow cross-sectional area of the input aperture of the input point is smaller than the flow cross-sectional area of the channel between the channel part comprising the elastic wall and the conveying pipe.

11. Input point according to claim 8, wherein the input point comprises a number of input apertures, in which case the combined flow cross-sectional area of the input apertures that are open is smaller than the flow cross-sectional area of the channel between the channel part comprising an elastic wall and the conveying pipe.

12. Input point according to claim 8, wherein the input point comprises an envelope part outside in the radial direction the wall that changes its shape, in which envelope part is formed an aperture or a number of apertures, the pressure surrounding which is able to act on the wall that changes its shape.

13. Input point according to claim 8, wherein the wall part that changes its shape is configured to close the connection between the input aperture and the conveying pipe or to essentially reduce the flow cross-sectional area of the pathway of the channel as a consequence of the pressure difference between the suction effect brought about in the channel by the partial-vacuum generator of the pneumatic material conveying system and the pressure prevailing outside the wall part that changes its shape.

14. Input point according to claim 8, wherein an input point for material is an input point for waste material or recyclable material.

15. Input point according to claim 8, wherein an input point for material is configured to function as a rubbish collection point, such as a litter bin.

16. Input point according to claim 8, wherein the wall changing its shape is a collapsible or contractible part, such as a sock or hose, owing to the negative pressure acting inside the space bounded by it.

17. Input point according to claim 8, wherein the wall changing its shape comprises a flexible sealing material, e.g. rubber or plastic.

18. Input point according to claim 8, wherein the wall changing its shape comprises reinforcing fabric, such as steel fabric, on which is arranged a sealing material, such as rubber or plastic, on the side of the inner wall.

19. Pneumatic material conveying system, which comprises at least one input point for material, which is connected to conveying piping for material, means for achieving a partial vacuum/pressure difference/transporting air flow in the conveying piping, and also a material container, into which the material to be transported together with the transporting air is conducted and in which the transporting air and the material to be transported are separated from each other, comprising:
a channel part is arranged between the material input aperture of an input point and the conveying pipe, which channel part comprises a wall that changes its shape, which elastic wall is configured to close the pathway between the input aperture and the conveying pipe or to essentially reduce the flow cross-sectional area of the pathway of the channel, when the pressure in the channel is essentially smaller than outside the wall part that changes its shape.

20. System according to claim 19, wherein the system comprises a number of input points arranged along the conveying piping, for emptying which input points the suction side of a partial-vacuum generator is connected to the material container and from where there is a flow connection onwards into the conveying pipe.

21. System according to claim 19, wherein the system comprises a material container, which is a transportation container.

22. System according to claim 19, wherein the system further comprises a material container, which is a deep collection container-separating device, into which material is conveyed from input points via a conveying pipe by means of suction/a pressure difference produced by a partial-vacuum source, and that in the emptying phase the collection container is lifted with lifting means and the material that has collected in the collection container is emptied via an openable and closable aperture arranged in the bottom part of the collection container.

23. (canceled)
